(19) United States
(12) Patent Application Publication
(10) Pub. No.: US 2023/0284568 A1
(43) Pub. Date: Sep. 14, 2023

(54) FREE-STANDING FLORAL FLAME

(71) Applicant: KANIZSA DESIGNS INC., Surrey (CA)

(72) Inventor: Alisha Bibi MOHAMED, Surrey (CA)

(21) Appl. No.: 18/040,506

(22) PCT Filed: Aug. 5, 2021
(86) PCT No.: PCT/IB2021/057214

§ 371 Date: Feb. 3, 2023

Related U.S. Application Data
(60) Provisional application No. 63/061,338, filed on Aug. 5, 2020.

(51) Int. Cl. A01G 5/04; A01G 5/06

(52) U.S. Cl. CPC A01G 5/04; A01G 5/06

(57) ABSTRACT

A floral structure includes: a shaped backing defining a mounting surface having a perimeter, the mounting surface configured to receive a plurality of floral supports bearing respective flowers; and a frame affixed to the shaped backing and surrounding the perimeter of the mounting surface, the frame configured to (i) form an open cavity adjacent to the mounting surface, and (ii) support the shaped backing in a free-standing arrangement relative to a surface.

### CROSS-REFERENCE TO RELATED APPLICATION

This application claims priority to US Provisional Application No. 63/061,338, filed Aug. 5, 2020, the contents of which is incorporated herein by reference.

### BACKGROUND

Floral structures may be used for decoration. However, in many cases, floral structures are limited in flexibility in shape and configuration. In addition, floral structures are usually displayed outdoors with live flowers, are hence limited in lifespan.

### SUMMARY

An aspect of the specification provides a floral structure including: a shaped backing defining a mounting surface having a perimeter, the mounting surface configured to receive a plurality of floral supports bearing respective flowers; and a frame affixed to the shaped backing and surrounding the perimeter of the mounting surface, the frame configured to (i) form an open cavity adjacent to the mounting surface, and (ii) support the shaped backing in a free-standing arrangement relative to a surface.

Another aspect of the specification provides method of constructing a floral structure, the method comprising: cutting a sheet to create a shaped backing defining a mounting surface having a perimeter, the mounting surface configured to receive a plurality of floral supports bearing respective flowers; creating a frame to surround a perimeter of the mounting surface; and connecting the frame to the shaped backing to (i) define an open cavity adjacent to the mounting surface, and (ii) support the shaped backing in a free-standing arrangement relative to a surface.

### BRIEF DESCRIPTION OF THE DRAWINGS

FIG. 1 is a perspective view of an example floral frame.

FIG. 2 is a side view of the example floral frame of FIG. 1.

FIG. 3 is a perspective view of an example brace.

FIG. 4 is a side view of the example brace of FIG. 3.

FIG. 5 is a top view of the example brace of FIG. 3.

FIG. 6 is a flowchart of an example method for constructing a floral frame.

FIG. 7. is a side view of the example floral frame of FIG. 1 with a flower and flower support attached.

FIG. 8 is a side view of the example floral frame of FIG. 1 with a plurality of flowers and a plurality of flower supports attached.

FIG. 9 is a perspective view of another example of a floral frame.

FIG. 10 is a perspective view of another example of a floral frame.

FIG. 11 is a side view of the example floral frame of FIG. 1 with a plurality of flowers attached to both sides of shaped backing.

### DETAILED DESCRIPTION

This disclosure relates to a floral frame that can use fresh and/or preserved flowers, and can be placed indoors or outdoors. The floral frame can also be placed for an extended period of time when preserved flowers are used, e.g for durations of at least 6 months to 2 years. In addition, the floral frame may be viewed from multiple angles, and may be used as center pieces. The floral frame is also free-standing, allowing it to be placed on multiple surfaces. That is, the floral frame can be placed on any of a wide variety of substantially horizontal support surfaces, supporting itself solely by the contact(s) between the floral frame and the support surface, without requiring attachment or other contact to any other external structure.

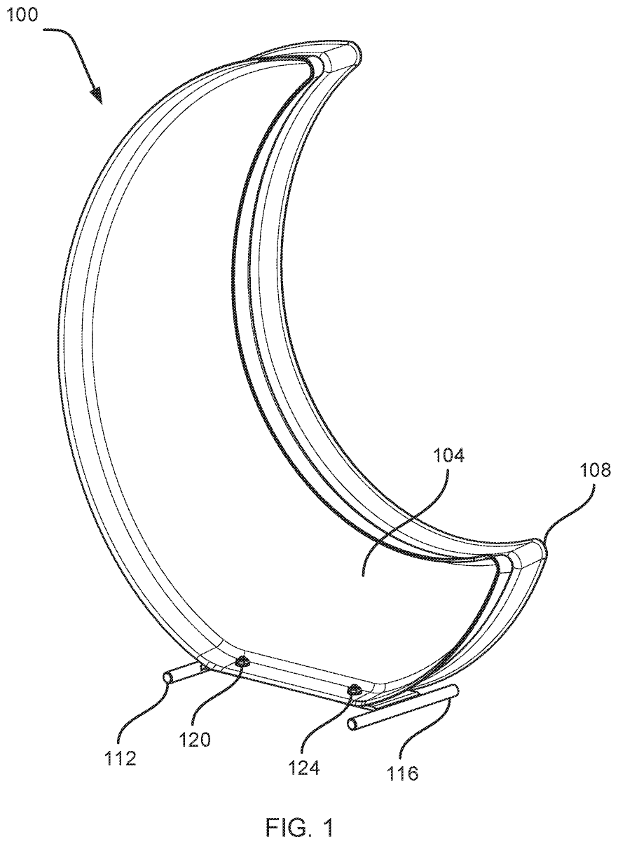

FIG. 1 shows a floral frame 100. Floral frame 100 may hold flowers in a free-standing sculpture. Floral frame 100 may also referred to as a floral sculpture.

Floral frame 100 includes a shaped backing 104, and a frame 108. In some examples, the frame 108 itself can support the sculpture 100 on a support surface. In other examples, the floral frame 100 can include additional structural elements to rest on a support surface, such as support braces 112, 116, and frame holes 120, 124.

Shaped backing 104 functions as a structural component of floral frame 100. Shaped backing 104 also functions as a foundation for mounting flowers and flower supports. This will be explained further below.

Shaped backing 104 can be any shape. In the example in FIG. 1, shaped backing 104 is in the shape of a moon. Other potential shapes may include, but are not limited to, the shape of a sun, a star, letters in the alphabet, astrological, zodiac or horoscope signs, or an animal. More generally, as will be apparent to those skilled in the art from the above examples, the shape of the backing 104 can be selected to support flowers in any of a wide variety of arrangements to suit the aesthetic requirements of the sculpture 100, while the frame 108 and/or additional supporting elements such as braces 112 and 116 enable the shaped backing 104 to remain free-standing.

Shaped backing 104 may also be composed of multiple pieces. In other embodiments, shaped backing 104 may be arranged in different manners to produce a three-dimensional shape. For example, shaped backing 104 may be in the shape of a “Y”, where shaped backing 104 splits part way along the height of floral frame 100 to form the top two prongs of the “Y” shape.

Shaped backing 104 may be made of a material that is sufficiently stiff to support the weight of flowers while remaining a free-standing structure. Shaped backing 104 may be made of materials including, but not limited to, cardboard, plastic, floral foam, other foams, and metal (including combinations thereof).

Frame 108 surrounds the perimeter of shaped backing 104. Frame 108 provides further structural support to floral frame 100. In the current example, where shaped backing 104 is a two dimensional shape of a moon, frame 108 provides an extrusion of the moon shape along the edge of shaped backing 104, perpendicular to the surface of shaped backing 104. This provides a three dimensional shape to be used in floral frame 100 as part of the free-standing sculpture.

Frame 108 may be made of many pieces, or may be made of a single piece. Different embodiments and different shapes may lead to frame 108 being constructed of many pieces or a single piece for ease of construction. For example, as depicted in FIG. 1, frame 108 is a single piece, curved around the points of the moon. However, it may be contemplated that other shapes with more corners, or sharper corners would benefit from a frame 108 with multiple pieces for ease of construction.

Frame 108 may be made of any of any rigid material sufficiently stiff to support the weight of floral frame 100 and attached flowers, while remaining a stable free-standing structure. Rigid materials include, but are not limited to, cardboard, cardstock paper, plastic, and metal. As will be apparent, the shaped backing 100 and frame 108 can be, but need not be, made of the same material or combination or materials.

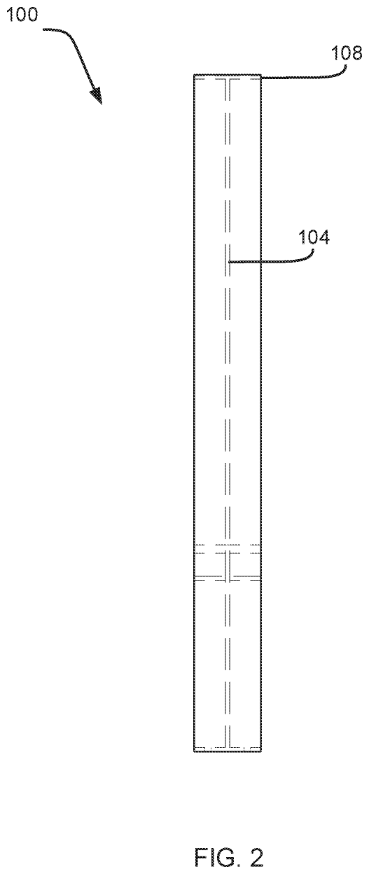

Referring to FIG. 2, a side view of floral frame 100 (without braces 112 and 116) is presented. In the current embodiment, shaped backing 104 is connected at the midpoint along the width of frame 108. This creates a cavity on both sides of shaped backing 104, allowing flowers and flower supports to be mounted on both sides of shaped backing 104. In other embodiments, shaped backing 104 may be connected to frame 108 closer to one edge, creating a cavity on one side of shaped backing 104. In this embodiment, flowers and flower supports may be mounted on one side of floral frame 100. Mounting of the flowers and flower supports will be further discussed below.

Braces 112 and 116 are connected to the bottom of frame 108. Braces 112 and 116 facilitate supporting frame 108 and shaped backing 104, allowing frame 108 and shaped backing 104 to be free-standing.

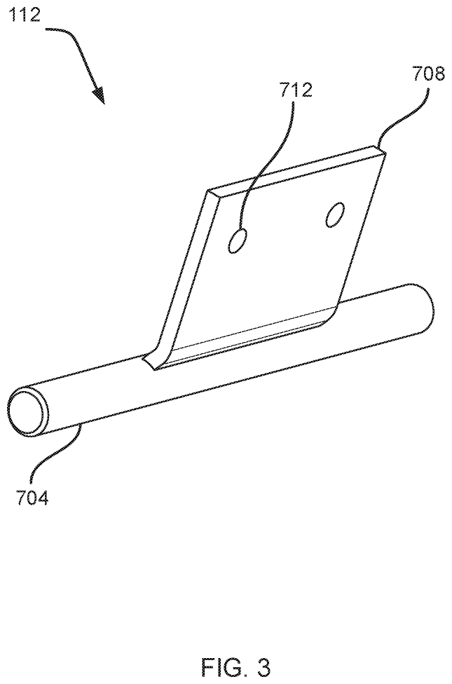

Referring to FIG. 3, an example brace 112 is depicted. Brace 112 includes foot 704, connector support 708, and bolt hole 712. In the current embodiment, foot 704 has a cylindrical shape. Foot 704 facilitates as the base for floral frame 100. When placed on a flat surface, such as a table, or the floor, the cylindrical shape of foot 704 has a greater width than frame 108, providing additional support for floral frame 100 to prevent floral frame 100 from tipping over. Other shapes of foot 704, such as a right rectangular prism, are contemplated to provide support and prevent floral frame 100 from tipping.

Connector support 708 provides a surface upon which brace 112 may be placed flush against frame 108. Connector support 708 includes a flat portion and an angled portion. The angled portion of connector support 708 may be at different angles to foot 704. In the current example, connector support 708 is at a 135 degree angle from foot 704. In addition, in the current example, the flat portion of connector support 708 is flat to be flush with frame 108. In other embodiments, the flat portion of connector support 708 may also be curved to conform to a flush fit with frame 108. Connector support 708 also provides a surface upon which bolt hole 712 can be placed. In the current example, bolt hole 712 allows for a nut and bolt to secure brace 112 to frame 108. Other forms of attaching brace 112 to frame 108 may be contemplated, including but not limited to glue, rivets, fasteners, and sealants. In addition, other combinations of foot 704, connection support 708 and bolt hole 712 may be contemplated.

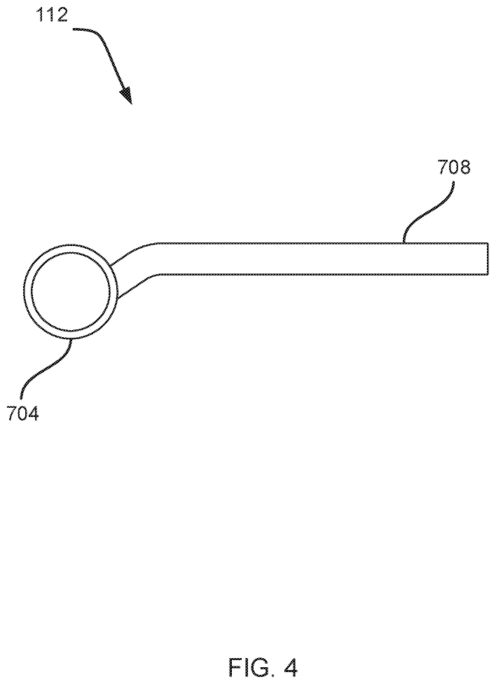

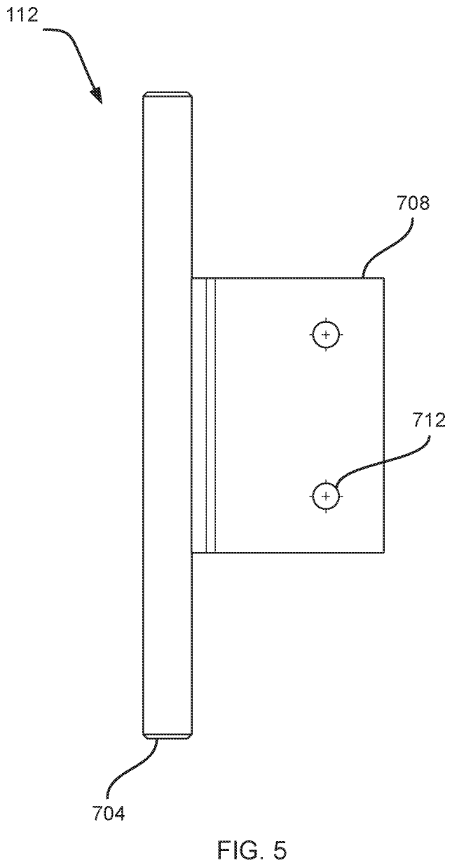

FIG. 4 depicts example brace 112 from a side view. FIG. 5 depicts example brace 112 from a top view.

Returning to FIG. 1, in the current embodiment, frame holes 120 and 124 facilitate as connection points for bolts to connect braces 112 and 116 respectively to frame 108. In the current embodiment, frame holes 120 and 124 are on either side of shaped backing 104, on frame 108. As indicated above, different forms of connecting braces 112 and 116 to frame 108 may be contemplated.

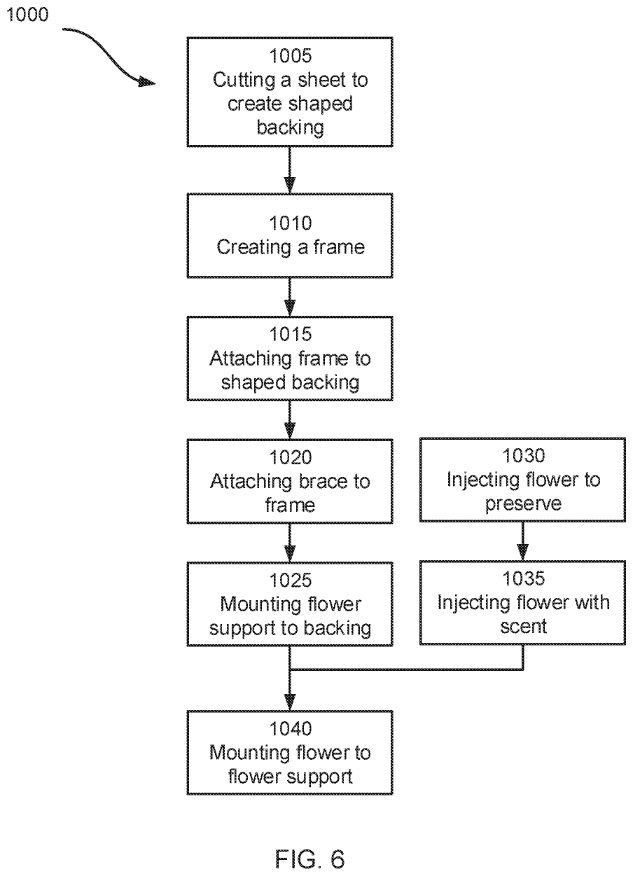

Referring to FIG. 6, an example method 1000 of constructing floral frame 100 is depicted. At block 1005, a sheet of metal, wood, cardboard, card stock, or other shaped backing 104 material is cut to create shaped backing 104. If shaped backing 104 consists of more than one sheet, then multiple sheets are cut and then assembled to create shaped backing 104.

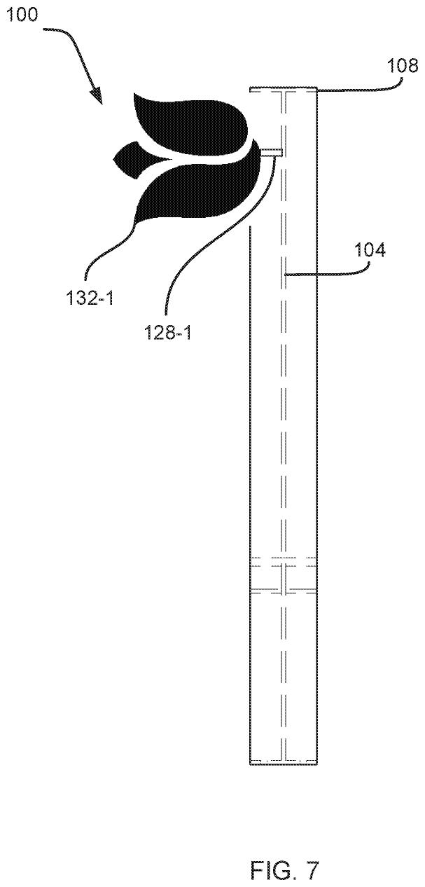

At block 1010, frame 108 is created. At block 1015, frame 108 is attached to shaped backing 104, where frame 108 surrounds the perimeter of shaped backing 104. In the current embodiment, shaped backing 104 is placed at the midpoint of the width of frame 108 as depicted in FIG. 2. Shaped backing 104 is connected to frame 108 through glue, rivets, fasteners or other means of attaching shaped backing 104 to frame 108. This creates two cavities, one on each side of shaped backing 104, for the placement of flowers 132 and flower supports 128 as can be seen in FIG. 7. Flowers 132 may also be referred to as flowers 132-1, 132-2, 132-3, 132-4 . . . 132-n. Flower supports 128 may also be referred to as flower supports 128-1, 128-2, 128-3, 128-4 . . . 128-n. The flower supports 128 are illustrated as partial stems of the flowers 132, or artificial rods attached to the flowers 128. In the illustrated example, the supports 128 have a length (perpendicular to the mounting surface of the backing 104) that exceeds the width of the supports 128). In other examples, the supports can be implemented as discs, e.g. of floral foam or other suitable material(s), with widths that exceed the lengths thereof. As mentioned above, shaped backing 104 may also be placed towards the edge of frame 108, creating a single cavity for the placement of flowers 132 and flower supports 128.

At block 1020, braces 112 and 116 are connected to frame 108. In the current embodiment, this is done using a series of bolts and nuts going through connector holes 120 and 124 on frame 108 and bolt holes 712 on braces 112 and 116. As indicated above, different methods of connecting braces 112 and 116 to frame 108 are contemplated, including, but not limited to, glue, fasteners and rivets. In other embodiments, as noted earlier, floral frame 100 may be in a shape where braces 112 and 116 may be omitted, allowing floral frame 100 to be free-standing on its own on the flat surface of frame 108.

At block 1025, flower supports 128 are mounted onto shaped backing 104. Flower supports 128 are mounted perpendicular to the surface of shaped backing 104 as depicted in FIG. 7 with flower support 128-1.

In parallel, or in sequence, at blocks 1030 and 1035, flowers 132 are prepared. In the current embodiment, at block 1030, flowers 132 may be preserved. An example of the preservation process includes the dehydration of flowers 132, e.g. using alcohol, submerging or otherwise infusing flowers 132 with a preservation compound, applying color dye through infusion, and allowing flowers 132 to dry. Flowers 132 may be preserved independently from construction and assembly of floral frame 100. In other embodiments, preservation may be omitted, and floral frame 100 may use flowers 132 that are not preserved.

In the current embodiment, at block 1035, flowers 132 are infused with a scent through a process whereby the flowers 132 are injected with a mixture of essential oil fragrance by way of a syringe.

Blocks 1030 and 1035 are performed to augment flowers 132 to enhance the enjoyment and lifespan of floral frame 100. Other methods of enhancing the enjoyment and lifespan of floral frame 100 are contemplated. In other embodiments, flowers 132 may be left in their fresh state and blocks 1030 and 1035 may be optional.

At block 1040, flowers 132 may be mounted to flower supports 128. Referring to FIG. 7, in the current embodiment, flower 132-1 is mounted to flower support 128-1, where the pistil of the flower is in line with the flower support, and perpendicular to shaped backing 104. Flower 132-1 is mounted such that a portion of flower 132-1 is protruding past the width of frame 108, i.e. outside the above-mentioned cavity. Where a fresh flower is used instead of a preserved flower, the flower supports 128 may be in the form of foam backing or other similar materials.

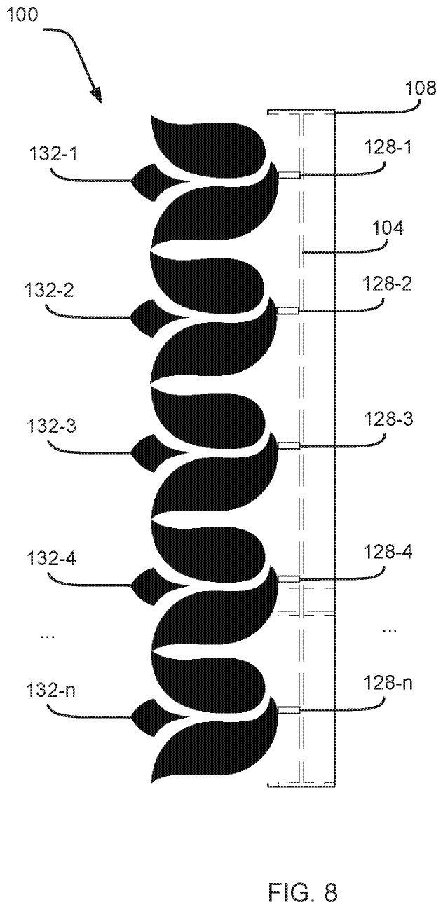

FIG. 8 depicts floral frame 100 after repeating the process of mounting flowers 132 and flower supports 128 on the first side of shaped backing 104. In the current embodiment, flowers 132-1, 132-2, 132-3, 132-4 . . . 132-n line the cavity on the first side of shaped backing 104. Continuing with the current embodiment, flowers 132 and flower supports 128 may be mounted on the second side of shaped backing 104. This allows for floral frame 100 to have flowers 132 in sight when viewing floral frame 100 from different viewing angles, including both sides of floral frame 100.

Flowers 132 and flower supports 128 may be mounted through multiple means. In the current embodiment, glue is used to mount flowers 132 onto flower supports 128. Glue is also used to mount flower supports 128 to shaped backing 104. Other means of mounting may be contemplated. In addition, flowers 132 may be connected directly to shaped backing 104 through similar means if flower supports 128 are not required. An example of this may be if flowers 132 are large enough to protrude past frame 108, that flower supports 128 may not be required. Other embodiments of mounting flowers 132 directly onto the surface of the backing 104 include attaching the stem of flowers 132 to surface backing 104 through glue, fasteners, or other means of attachment. The stem of flowers 132 are attached perpendicular to surface backing 104. In other examples, tubing may be placed over the stem of flowers 132 to hold the stems in place. In further examples, as noted above, the flowers 132 can be affixed to discs, which can in turn be affixed to the backing 104 (e.g. via adhesives or other mechanisms mentioned herein).

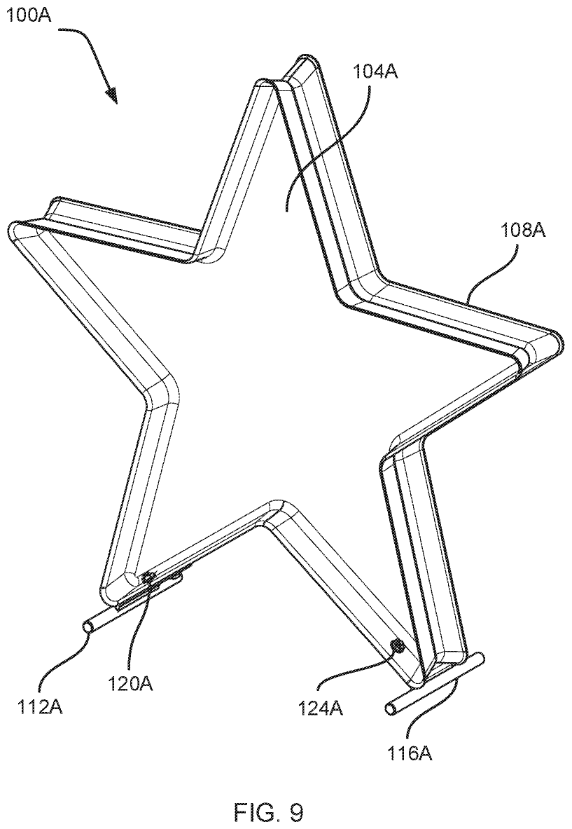

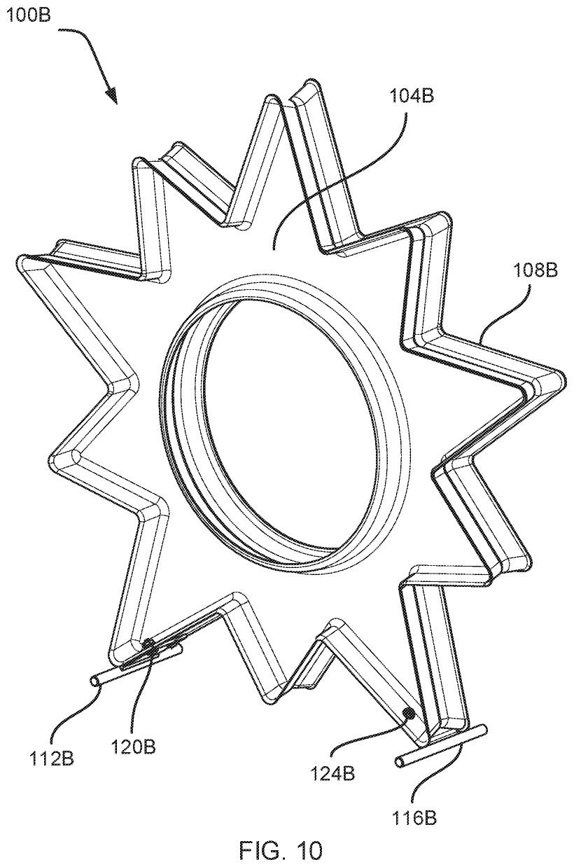

FIG. 9 and FIG. 10 depict different embodiments of floral frame 100. Floral frame 100 is in the shape of a moon. FIG. 9 depicts floral frame 100A in the shape of a star. FIG. 10 depicts floral frame 1006 in the shape of a sun.

Referring to FIG. 9, shaped backing 104A, frame 108A, braces 112A, 116A, and connector holes 120A and 124A are all different embodiments of shaped backing 104, frame 108, braces 112, 116 and connector holes 120 and 124 in floral frame 100.

Referring to FIG. 10, shaped backing 104B, frame 108B, braces 112B, 116B, and connector holes 120B, and 124B are all different embodiments of shaped backing 104, frame 108, braces 112, 116 and connector holes 120 and 124 in floral frame 100.

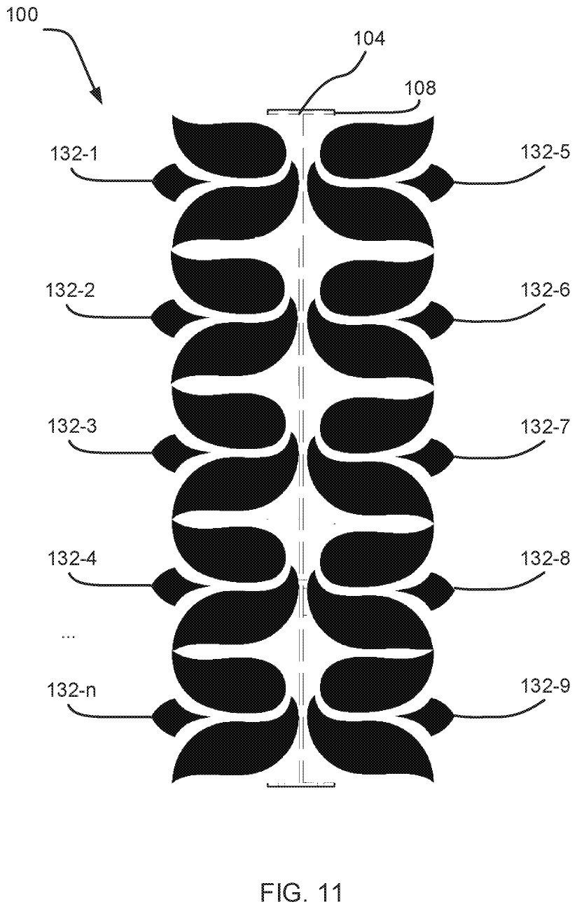

Referring to FIG. 11, an embodiment of floral frame 100 where shaped backing 104 is attached to the midpoint of width 108, creating two cavities for flowers 132 is depicted, as is explained above. In this embodiment, flowers 132 are attached directly to surface backing 104 in both cavities.

It should be recognized that features and aspects of the various examples provided above can be combined into further examples that also fall within the scope of the present disclosure. In addition, the figures are not to scale and may have size and shape exaggerated for illustrative purposes.

1. A floral structure comprising:
a shaped backing defining a mounting surface having a perimeter, the mounting surface configured to receive a plurality of floral supports bearing respective flowers; and
a frame affixed to the shaped backing and surrounding the perimeter of the mounting surface, the frame configured to (i) form an open cavity adjacent to the mounting surface, and (ii) support the shaped backing in a free-standing arrangement relative to a surface.

2. The floral structure of claim 1, further comprising a brace connected to the frame and configured to rest on the surface to support the floral structure in the free-standing arrangement.

3. The floral structure of claim 1, further comprising:
a flower connected to the mounting surface, wherein a pistil of the flower is perpendicular to the shaped backing; and
wherein a stem of the flower is secured to the mounting surface of the shaped backing within the open cavity, a portion of the flower protruding outside the open cavity.

4. The floral structure of claim 1, the frame comprised of a single sheet bent around the perimeter.

5. The floral structure of claim 1, the frame comprised of a plurality of sheets affixed around the perimeter.

6. The floral structure of claim 3, wherein the flower contains a preservative.

7. The floral structure of claim 3, wherein the flower contains an infused artificial scent.

8. The floral structure of claim 1, wherein the shaped backing includes a second mounting surface opposite the mounting surface; and
wherein the shaped backing is affixed at a midpoint of a width of the frame, to define the open cavity adjacent to the mounting surface, and a second open cavity adjacent to the second mounting surface.

9. The floral structure of claim 8, further comprising:
a first plurality of flowers connected the mounting surface, a portion of each of the flowers in the first plurality protruding from the open cavity; and
a second plurality of flowers connected to the second mounting surface, a portion of each of the flowers in the second plurality protruding from the second open cavity.

10. A method of constructing a floral structure, the method comprising:
cutting a sheet to create a shaped backing defining a mounting surface having a perimeter, the mounting surface configured to receive a plurality of floral supports bearing respective flowers;
creating a frame to surround a perimeter of the mounting surface; and
connecting the frame to the shaped backing to (i) define an open cavity adjacent to the mounting surface, and (ii) support the shaped backing in a free-standing arrangement relative to a surface.

11. The method of claim 10, further comprising attaching a brace to the frame, the brace configured to rest on the surface to support the floral structure in the free-standing arrangement.

12. The method of claim 10, further comprising mounting a flower to the mounting surface such that a portion of the flower protrudes from the open cavity.

13. The method of claim 12, further comprising applying a preservative to the flower.

14. The method of claim 12, further comprising infusing the flower with an artificial scent.

15. The method of claim 10, further comprising connecting the shaped backing at the midpoint of a width of the frame.
